(19) United States
(12) Patent Application Publication
(10) Pub. No.: US 2014/0236773 A1
(43) Pub. Date: Aug. 21, 2014

(54) 3D Printer Based Product Delivery System and Methods

(71) Applicants: Madison A. Hamilton, Littleton, CO (US); McKenzie L. Hamilton, Littleton, CO (US); Stanton M. Hamilton, Littleton, CO (US); Jacob D. Hamilton, Littleton, CO (US)

(72) Inventors: Madison A. Hamilton, Littleton, CO (US); McKenzie L. Hamilton, Littleton, CO (US); Stanton M. Hamilton, Littleton, CO (US); Jacob D. Hamilton, Littleton, CO (US)

(21) Appl. No.: 14/254,802

(22) Filed: Apr. 16, 2014

(51) Int. Cl. G06Q 30/06

(52) U.S. Cl. CPC G06Q 30/0635
USPC 705/26.81

(57) ABSTRACT

A product delivery system operable to deliver a virtual product which is manufactured locally using a 3D printer, and methods for using such.

### BACKGROUND OF THE INVENTION

The present invention is related to product delivery, and more particularly to the approaches and systems for efficient product delivery.

Shipping of products and later returns of warranty of those products is a complex and expensive process that typically adds considerable cost to a product.

Thus, for at least the aforementioned reasons, there exists a need in the art for more advanced product delivery approaches.

### BRIEF SUMMARY OF THE INVENTION

The present invention is related to product delivery, and more particularly to the approaches and systems for efficient product delivery.

Various embodiments of the present invention provide product delivery systems that include: an order entry system operable to provide product request information to a product supplier and to provide local production capability information to the product supplier; and a product receiving system operable to receive a product construction specification from the product supplier. The product construction specification corresponds to the product request information. A 3D printer operable to produce a product corresponding to the product construction specification.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a system in which the design supplier can communicate with the 3D printer via various channels.

FIG. 2 is a flow diagram illustrating a method in accordance with various embodiments of the present invention for 3D printing products on the user's side;

FIG. 3 is a flow diagram illustrating a method in accordance with various embodiments of the present invention for 3D printing products on the supplier's side;

FIG. 4 is a flow diagram illustrating a method in which to print all the components of a design off of one design;

FIG. 5 is a flow diagram illustrating a method of determining how to assemble a design using numbered parts and a PDF file; and

FIG. 6 is a flow diagram illustrating a method of determining how to print a single part of a design that has been broken and needs to be replaced without printing the entire design again.

### DETAILED DESCRIPTION OF THE INVENTION

The present invention is related to product delivery, and more particularly to the approaches and systems for efficient product delivery.

Various embodiments of the present invention provide product delivery systems that include: an order entry system operable to provide product request information to a product supplier and to provide local production capability information to the product supplier; and a product receiving system operable to receive a product construction specification from the product supplier. The product construction specification corresponds to the product request information. A 3D printer operable to produce a product corresponding to the product construction specification.

In some instances of the aforementioned embodiments, the local production capability information includes an indication of a material stock available to the 3D printer. In some cases, the material stock includes two or more different types of material stock. In various cases, the local production capability information includes an indication of the 3D printer type.

In various embodiments of the present invention, the local production capability information includes an indication of a material stock available to the 3D printer, and an indication of the 3D printer type. The product supplier is operable to provide a rejection in response to the product request information based upon one or both of the 3D printer type and the material stock. In particular instances of the aforementioned embodiments, the product construction specification are instructions for the 3D printer. In one or more embodiments of the present invention, the product is a multi-part product, and the product receiving system is further operable to receive product assembly instructions from the product supplier.

In some embodiments of the present invention, the product request information is a first product request information, and the order entry system is further operable to: receive an indication of a broken part of the product, and provide a second product request information to the product supplier. The second product request information is limited to the broken part of the product. In some cases, the product construction specification is a first product construction specification. The product receiving system is further operable to receive a second product construction specification from the product supplier, and the second product construction specification corresponds to the second product request information. In particular cases, the product is a multi-part product, and the product receiving system is further operable to receive product dis-assembly and re-assembly instructions from the product supplier directing a user how to replace the broken part in the product.

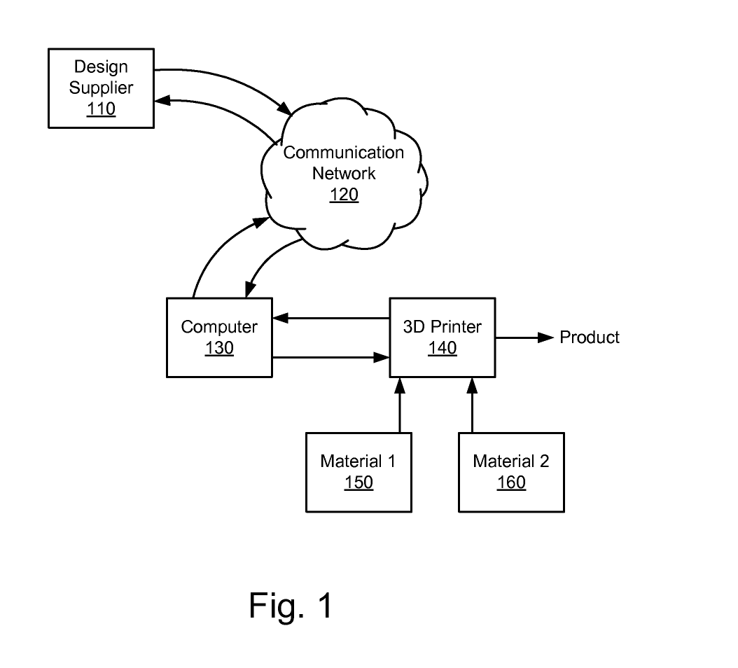

Turning to FIG. 1, a block diagram of a system including the needed parts for a 3d printed product. The system includes a design dealer system operable to send and receive information regarding a 3D printer via a communication system and a computer system; a computer system operable to send and receive information from a 3D printer and a design dealer; and a 3D printer system operable to print given designs and to send and receive information from the computer system. The information mentioned above consists of, but is not limited to, information on the accuracy of the printer, materials the printer is able to use, materials currently in the printer, and information on payment for the design. The Designs for the printer will consist of the necessary printer requirements for the design, information on the materials required, instructions for the 3D printer, separately numbered individual parts, and instructions for assembly of the product for the user. If the requirements found in the design are met by the printer, the user is allowed to purchase the design. If the requirements in the design are not met by the printer the user will not be allowed to purchase the design.

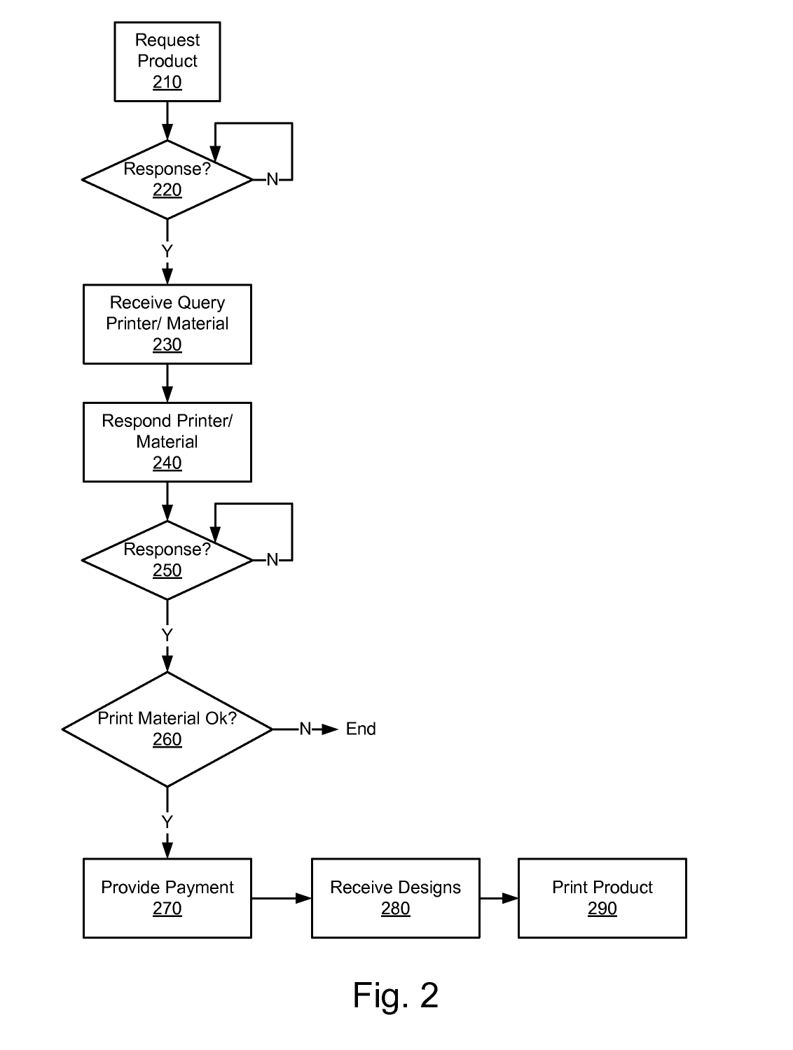

Turning to FIG. 2, a block diagram of the process in which a product is printed from the user's side. The user first request's a product 210. The system then waits for a response from the user to ensure that the printer is attached and ready. The system then will access the design for the requirements to print the product 230. When the design requirements are accessed it responds, to the user the material needed and the accuracy of the printer needed 240. The system will then wait for a response from the user of the material available 250. If the material available matches the design requirements 260 and the accuracy of the printer is correct it then proceeds to allow the user to provide payment for the design 270. When payment is received the system responds with sending 280 the designs to the user allowing them to print the product 290.

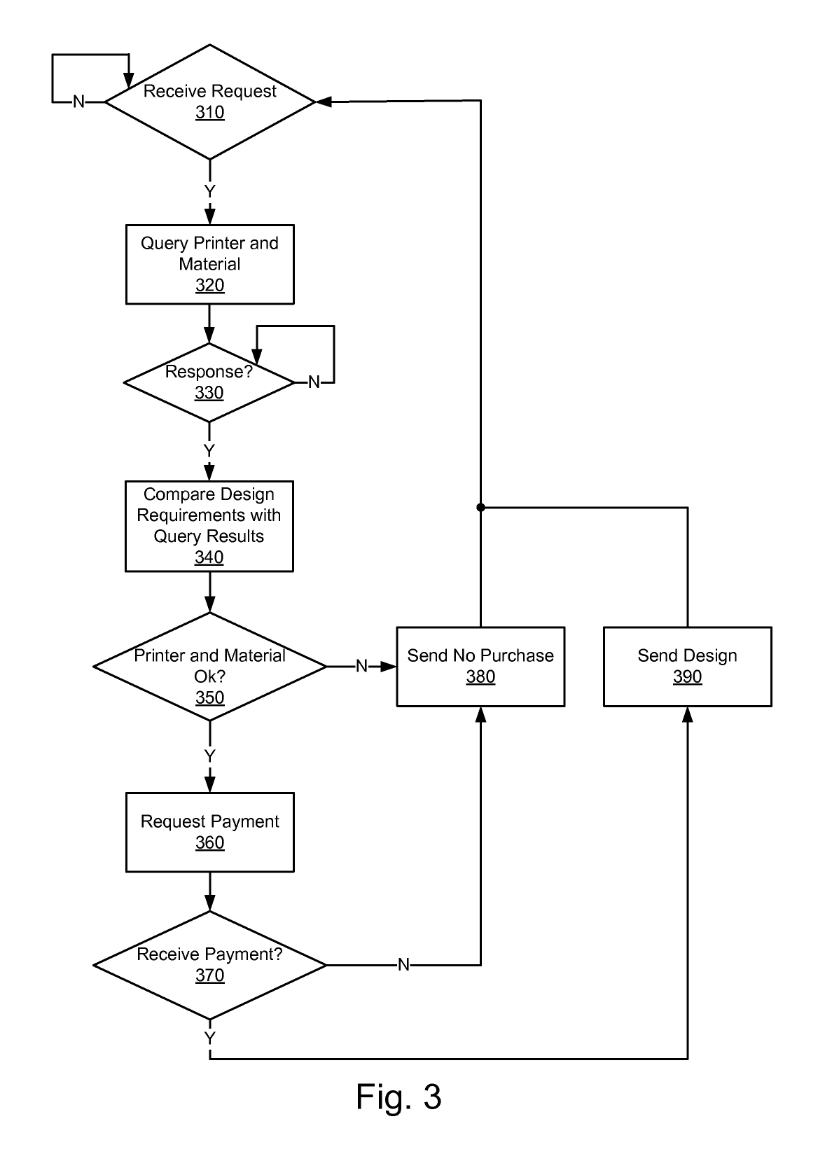

Turning to FIG. 3, a block diagram of the process in which a product is printed from the design supplier's side. The system will wait until a request for a design is made 310. Once a design is requested, the system will access the design for the design requirements 320. Using these design requirements the system will query the user's 3D printer for its accuracy and material abilities 330. The system will wait for a response from the printer 330. The user's 3D printer will then respond with its accuracy and material capabilities. The system will then compare the capabilities of the printer to the requirements of the design. If the design's requirements are not met by the user's 3D printer the system will send a no purchase message and not design is sent 390. If the requirements are met by the user's 3D printer then the system will proceed to ask the user to provide payment for the design 360. If payment is not received a no purchase message is sent and no design is sent and the system returns to waiting for a design request 390. If payment is received then a design is sent and the system returns to waiting for a design request 380.

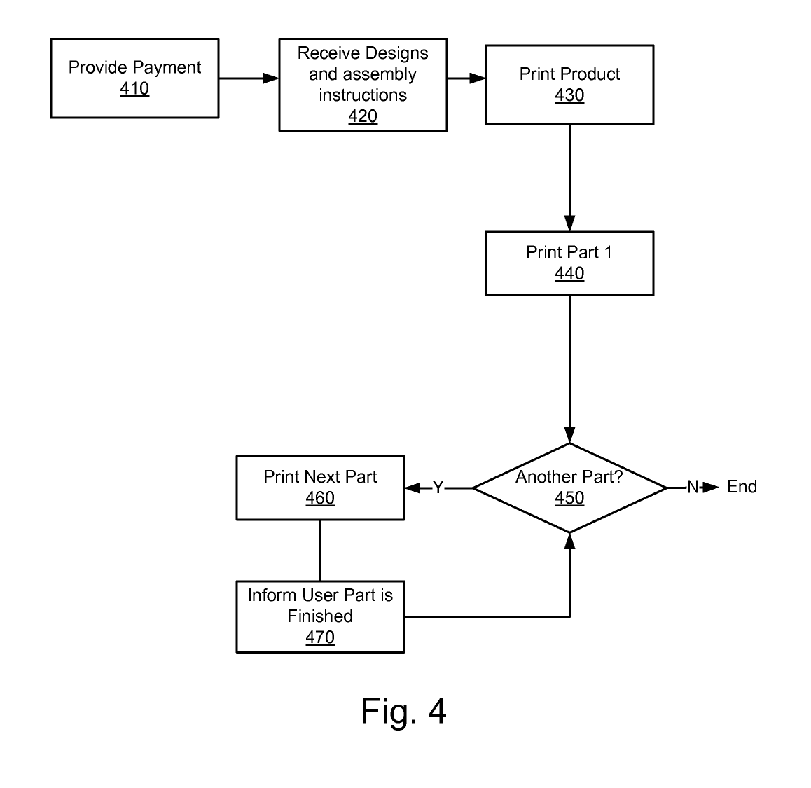

Turning to FIG. 4, a block diagram of the process in which the printer will print each individual part to be assembled. The system will wait until the design is sent to it by the supplier to begin printing the separate parts 420. The system will then proceed to print the first piece of the design 440. The system will then with for a response from the printer. When part one is completed, the system will notify the user that that part is finished. The system will then look to the design to see if there is another part 450. If the answer is no, then the system will stop printing and inform the user that it is done. If the answer is yes, the system will proceed to print the next part in the design 460. When that part is finished, the system will notify the user that the part is finished 470. The system will then look again to the design to see if there are any more parts to print within the design. This process will continue until all of the parts of the design are printed and finished. The system will then stop printing.

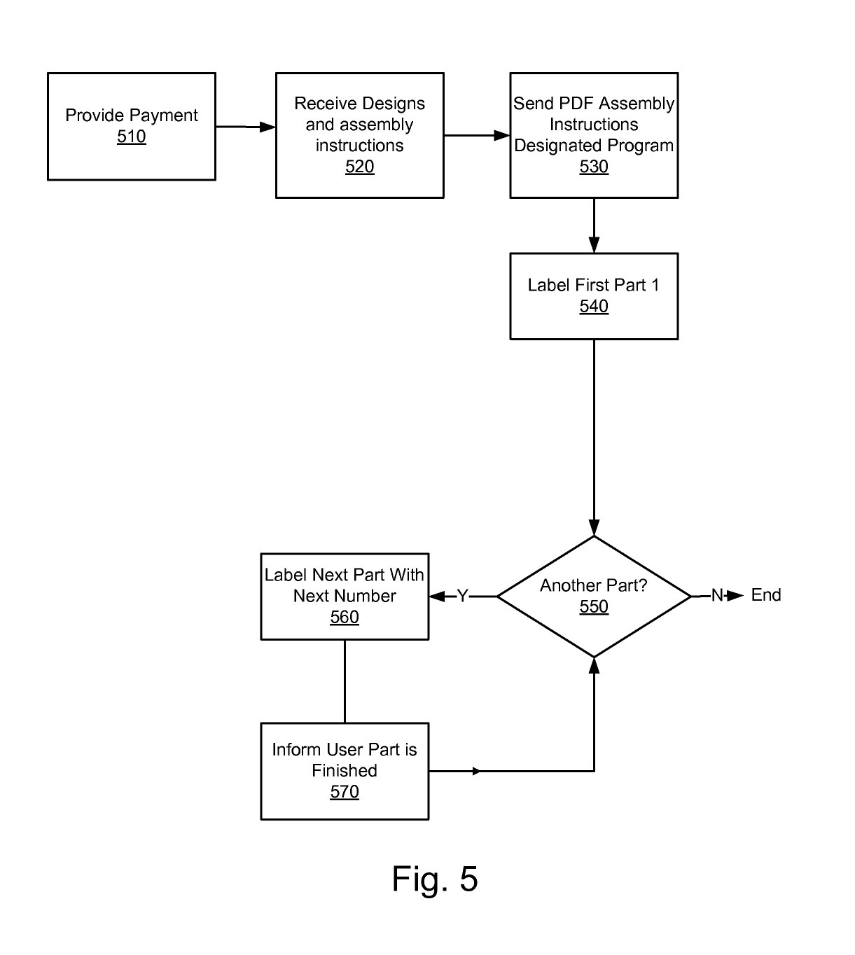

Turning to FIG. 5, a flow diagram illustrating a method of determining how to assemble a design using numbered parts and a PDF file. In designs where there is more than one moving part, each of the parts will be required to be numbered in sequence with each other in order to provide a way to assemble to different moving parts together into a whole design. The design supplier will be required to number each one of the parts in their design and they will also be required to send a PDF file with the instructions as to how to assemble the design once it has been printed. When the user requests to purchase a design from the design supplier 510, they will be required to provide an email address where a PDF file will be sent in order to from the supplier at the same time that the design is sent to the printer 520. The numbering for each of the pieces will come from the design and will correspond with the instructions inside the PDF file that will be sent with the design from the design supplier 540. As each piece of the design is labeled, they will be given a number that comes after the number for the previous piece 560. When all of the parts have been labeled, the process will stop 550.

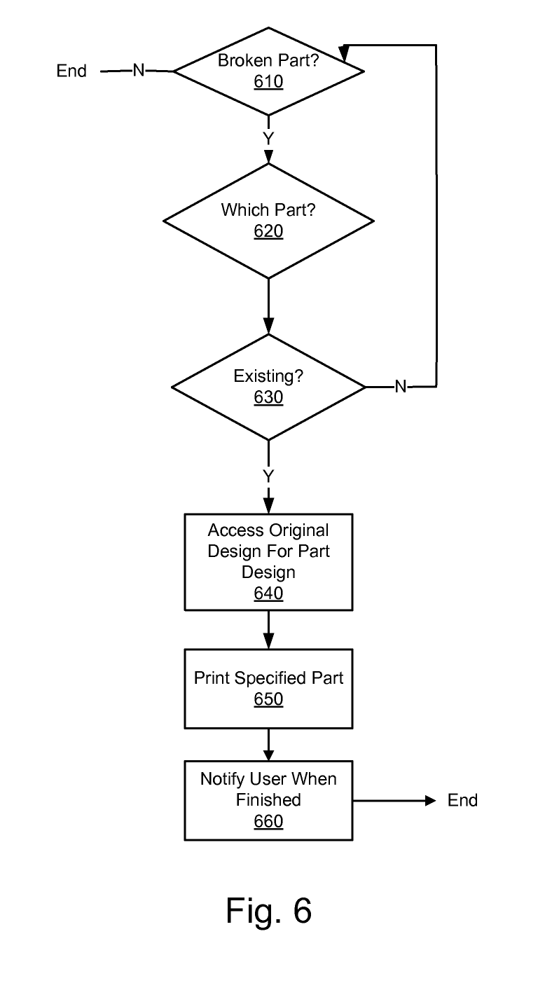

Turning to FIG. 6, a flow diagram illustrating the process in which to print a single part that has been broken and needs to be replaced without printing the entire design again. If there is no broken part, the method will end. If there is a broken part, the user must first identify that there is a broken part in the printed product 610. Then they must identify what part is broken and must be reprinted 620. After this, they must input which part needs to be replaced into the system so that it can be reprinted. The system will then go back into the original design. The system must find if the part is exists in the original design for the product 630. If the part does not exist within the original design, the system will go back to the beginning of the method and ask the user to input which part needs to be reprinted. If the part does exist within the original design, the system will then proceed to access the original design to find how to print that specified part 640. The system will then proceed to print the specified part 650. When the system has finished printing the specified part, if will notify the user. The system will then stop printing.

In some cases where power control signal 132 is a binary signal, power control signal 132 pulses on and off as acceleration indicator 137 goes below the lower threshold and increases above the upper threshold. This pulse may be used as an enable to motor control 125 where motor control 125 applies power to the wheels in accordance with a command received via RF receiver 120 until acceleration indicator 137 exceeds the upper threshold, and disallows application of the power to the wheels for the period between when acceleration indicator 137 exceeds the upper threshold and when it returns to below the lower threshold. This results in full application of power by motor control 125 followed by zero power during a power off period (i.e., the period between when acceleration indicator 137 exceeds the upper threshold and when it returns to below the lower threshold). This pulsing of the power effectively reduces the power applied to the wheels and thereby reduces the possibility of flipping RC car 100.

What is claimed is:

1. A product delivery system, the product delivery system comprising:
an order entry system operable to provide product request information to a product supplier and to provide local production capability information to the product supplier;
a product receiving system operable to receive a product construction specification from the product supplier, wherein the product construction specification corresponds to the product request information; and
a 3D printer operable to produce a product corresponding to the product construction specification.

2. The product delivery system of claim 1, wherein the local production capability information includes an indication of a material stock available to the 3D printer.

3. The product delivery system of claim 2, wherein the material stock indicates at least a first material and a second material.

4. The product delivery system of claim 1, wherein the local production capability information includes an indication of the 3D printer type.

5. The product delivery system of claim 1, wherein the local production capability information includes an indication of a material stock available to the 3D printer, and an indication of the 3D printer type, and wherein the product supplier is operable to provide a rejection in response to the product request information based upon one or both of the 3D printer type and the material stock.

6. The product delivery system of claim 1, wherein the product construction specification are instructions for the 3D printer.

7. The product delivery system of claim 1, wherein the product is a multi-part product, and wherein the product receiving system is further operable to receive product assembly instructions from the product supplier.

8. The product delivery system of claim 1, wherein the product request information is a first product request information, wherein the order entry system is further operable to:
receive an indication of a broken part of the product, and
provide a second product request information to the product supplier, wherein the second product request information is limited to the broken part of the product.

9. The product delivery system of claim 8, wherein the product construction specification is a first product construction specification, wherein the product receiving system is further operable to receive a second product construction specification from the product supplier, and wherein the second product construction specification corresponds to the second product request information.

10. The product delivery system of claim 9, wherein the product is a multi-part product, and wherein the product receiving system is further operable to receive product dis-assembly and re-assembly instructions from the product supplier directing a user how to replace the broken part in the product.

11. The product delivery system of claim 1, wherein the order entry system is communicably coupled to the product supplier via a communication network.

12. The product delivery system of claim 1, wherein the product receiving system is communicably coupled to the product supplier via a communication network.

13. The product delivery system of claim 1, wherein the product receiving system is communicably coupled to 3D printer via a communication network.
